(19) United States
(12) Patent Application Publication
(10) Pub. No.: US 2001/0021449 A1
(43) Pub. Date: Sep. 13, 2001

(54) Foamed rubber, process for producing the same and composite comprising the foamed rubber

(76) Inventors: Junichi Koshiba, Ichihara-shi (JP); Tatsuo Sassa, Ichihara-shi (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/780,485

(22) Filed: Feb. 12, 2001

(30) Foreign Application Priority Data
Feb. 21, 2000 (JP) 2000-042470
Mar. 10, 2000 (JP) 2000-066903

(51) Int. Cl. B32B 3/26

(52) U.S. Cl. 428/315.7; 428/319.1; 264/46.4; 264/46.7

(57) ABSTRACT

A foamed rubber obtainable by a process including the steps of:

(1) blending 100 parts by weight of a rubber and 4-15 parts by weight of a blowing agent having a decomposition temperature of 170° C. or above, to obtain a composition,

(2) continuously molding the composition with a continuous molding apparatus, to obtain a molded body, and

(3) continuously heating the molded body to effect vulcanization and foaming, thereby to obtain a foamed rubber which has an average cell diameter of 1-150 μm, a hardness as determined according to JIS-K-6301 of 30-100 and a density of 0.7-1.1 kg/l, is light in weight and has a high hardness comparable to solid rubber, a high strength and a smooth surface.

### FIELD OF THE INVENTION

This invention relates to a foamed rubber, a process for producing the same and composites comprising the foamed rubber. In more particular, this invention relates to a foamed rubber which is light in weight and has a high hardness comparable to that of unfoamed rubber (hereinafter referred to as “solid rubber”), a high strength and a smooth surface, a process for producing the same and composites comprising the foamed rubber.

### BACKGROUND OF THE INVENTION

From the viewpoint of weight reduction of articles such as automobiles and from the viewpoint of economy of resources, namely reducing the amount of materials used for producing articles, it has been demanded that the materials are light in weight and have a high hardness, high strength and smooth surface. In the case of rubber materials, also, lightweight parts have been similarly demanded. As a means for meeting such a demand, foamed rubber which has a smooth surface and mechanical strength comparable to those of solid rubber has been eagerly desired. One of the techniques for obtaining foamed rubber having a smooth surface is to form a foamed rubber having fine cells. For example, JP-A-11-80459 discloses a foamed rubber having cells of minute diameters.

However, the foamed rubber disclosed in said patent publication has problems in that (i) it is a foamed rubber having an Asker c hardness of as low as 40 or less (namely, soft rubber) and (ii) since it is a foamed rubber obtained by batch-type die-molding process, it shows a poor productivity in the production of long molded rubber having a fixed sectional shape.

### BRIEF DESCRIPTION OF DRAWINGS

FIG. 1 is a drawing showing the appearance of one example of the composite of this invention, wherein numeral 1 indicates foamed rubber and 2 indicates a rigid body.

### SUMMARY OF THE INVENTION

The object of this invention is to provide a foamed rubber which is light in weight and has a high hardness comparable to that of solid rubber, a high strength and a smooth surface, a process for producing the same, and composites comprising the foamed rubber.

The present inventors have made extensive study to attain the above-mentioned object. AS the result, they have found that a foamed rubber which is light in weight and has a high hardness comparable to that of solid rubber, a high strength and a smooth surface can be obtained by continuously molding a mixture comprising a rubber and a blowing agent having a decomposition temperature of 170° C. or above to obtain a molded product and then continuously heating the molded product to effect vulcanization and foaming. This invention has been completed on the basis of the above finding.

Thus, this invention provides a foamed rubber which has an average cell diameter of 1-150 μm, a hardness as determined according to JIS-K-6301 of 30-100 and a density of 0.7-1.1 kg/l.

Further, this invention provides a process for producing a foamed rubber which comprises the steps of:

(1) blending a mixture comprising 100 parts by weight of a rubber and 4-15 parts by weight of a blowing agent having a decomposition temperature of 170° C. or above, to obtain a composition,

(2) continuously molding the composition with a continuous molding apparatus, to obtain a molded body, and

(3) continuously heating the molded body to effect vulcanization and foaming, thereby to obtain a foamed rubber which has an average cell diameter of 1-150 μm, a hardness as determined according to JIS-K-6301 of 30-100 and a density of 0.7-1.1 kg/l.

Furthermore, this invention provides a composite comprising a foamed rubber which has an average cell diameter of 1-150 μm, a hardness as determined according to JIS-K-6301 of 30-100 and a density of 0.7-1.1 kg/l and a rigid body integrally bonded to each other.

### DETAILED DESCRIPTION OF THE INVENTION

The term “foamed rubber” used in this invention means a rubber in which closed cells are present substantially uniformly dispersed throughout the whole rubber.

The term “rubber” used in this invention means the substance defined as RUBBER in ISO 1382 (1996). Examples of rubber in this invention include natural rubbers, styrene-butadiene rubbers, acrylonitrile-butadiene rubbers, butadiene rubbers, silicone rubbers, chloroprene rubbers, acrylic rubbers, ethylene-acrylic rubbers, fluororubbers, ethylene-α-olefin-non-conjugated diene copolymer rubbers, and combinations of two or more thereof. Preferred of these are ethylene-α-olefin-non-conjugated diene copolymer rubbers, which include, for example, ethylene-propylene-5-ethylidene-2-norbornene copolymer rubber (EPDM). As the rubbers, those which are commercially available can be used.

In ethylene-α-olefin-non-conjugated polyene copolymer rubbers typically represented by the above-mentioned ethylene-α-olefin-non-conjugated diene copolymer rubber, the “α-olefin” refers to a straight or branched 1-olefin having 3-20 carbon atoms. The α-olefin can be, for example, propylene 1-butene, 1-pentene, 1-hexene, 4-methyl-1-pentene, 1-octene, 1-decene and a mixture of these α-olefins. Preferred of these are propylene and 1-butene from the viewpoint of easy availability.

Non-conjugated polyenes in the above-mentioned ethylene-α-olefin-non-conjugated polyene copolymer rubbers can be, for example, chain-like non-conjugated dienes, such as 1,4-hexadiene, 1,6-octadiene, 2-methyl-1,5-hexadiene, 6-methyl-1,5-heptadiene and 7-methyl-1,6-octadiene; cyclic non-conjugated dienes, such as cyclohexadiene, dicyclopentadiene, methyltetraindene, 5-vinylnorbornene, 5-ethylidene-2-norbornene and 6-chloromethyl-5-isopropenyl-2-norbornene; trienes, such as 2,3-diisopropylidene-5-norbornene, 2-ethylidene-3-isopropylidene-5-norbornene, 2-propenyl-2,2-norbornadiene, 1,3,7-octatriene and 1,4,9-decatriene; 5-vinyl-2-norbornene, 5-(2-propenyl)-2-norbornene, 5-(3-butenyl)-2-norbornene, 5-(4-pentenyl)-2-norbornene, 5-(5-hexenyl)-2-norbornene, 5-(5-heptenyl)-2-norbornene, 5-(7-octenyl)-2-norbornene, 5-methylene-2-norbornene, 6,10-dimethyl-1,5,9-undecatriene, 5,9-dimethyl-1,4,8-decatriene, 4-ethylidene-8-methyl-1,7-nonadiene, 13-ethyl-9-methyl-1,9,12-pentadecatriene, 5,9,13-trimethyl-1,4,8,12-tetradecadiene, 8,14,16-trimethyl-1,7,14-hexadecatriene, 4-ethylidene-12-methyl-1,11-pentadecadiene, and the mixtures of two or more of these. Preferred of these are 5-ethylidene-2-norbornene; and combination of 5-ethylidene-2-norbornene and dicyclopentadiene from the viewpoint of easy availability.

The process for producing the ethylene-α-olefin-non-conjugated polyene copolymer rubber is not particularly limited. The copolymer rubber can be produced by using such catalysts as titanium-based catalysts, vanadium-based catalysts and metallocene-based catalysts.

The molar ratio of the unit derived from ethylene (hereinafter referred to as the “ethylene unit”, the same applies similarly to olefins, etc.) to the α-olefin unit (namely, ethylene unit/α-olefin unit) in the above-mentioned ethylene-α-olefin-non-conjugated polyene copolymer rubber ranges preferably from 1/0.1 to 1/1 from the viewpoint of the flexibility of the rubber. The molar ratio of the ethylene unit to the non-conjugated polyene unit (namely, ethylene unit/non-conjugated polyene unit) ranges preferably from 1/0.005 to 1/0.2 from the viewpoint of prevention of burning at the dies part in extrusion molding of the copolymer rubber and the viewpoint of the degree of vulcanization of the vulcanized rubber obtained.

The solution viscosity [η] of the ethylene-α-olefin-non-conjugated polyene copolymer rubber determined in xylene at 70° C. ranges preferably from 0.2 to 10, more preferably from 0.5 to 4. When the viscosity is less than 0.2, the cell diameter of the foamed rubber obtained exceeds 150 μm in some cases. On the other hand, when the viscosity exceeds 10, the extrusion molding of the copolymer rubber is impossible in some cases.

The average cell diameter of the foamed rubber of this invention ranges from 1 to 150 μm, preferably from 1 to 100 μm. When the average cell diameter is less than 1 μm, the density of the foamed rubber is less than 0.7 kg/l in some cases. On the other hand, when the average cell diameter exceeds 150 μm, the surface smoothness of the foamed rubber is deteriorated in some cases. The “average cell diameter” herein refers to the value obtained by measuring the diameters of the respective cells in the scanning electron microphotograph (magnification: 55×) of the section of the foamed rubber and dividing the sum of the diameters by the number of cells (namely, arithmetic mean value).

The hardness of the foamed rubber of this invention determined with a spring-type hardness tester A-type (JIS-K-6301) ranges from 30 to 100, preferably from 40 to 95. When the hardness is less than 30, the strength of the rubber as, for example, automobile sealing rubber is insufficient in some cases. On the other hand, when it exceeds 100, the flexibility of the rubber as, for example, automobile sealing rubber is insufficient in some cases.

The density of the foamed rubber of this invention ranges from 0.7 to 1.1 kg/l, preferably from 0.85 to 1.05 kg/l, more preferably from 0.90 to 1.0 kg/l. When the density is less than 0.7 kg/l, the cell diameter exceeds 150 μm and resultantly the surface smoothness of the foamed rubber is deteriorated in some cases. On the other hand, when the density exceeds 1.1 kg/l, the reduction of weight, one of the objects of this invention, cannot be attained in some cases.

The “blowing agent” used in this invention signifies a blowing agent having a decomposition temperature of 170° C. or above. The term “decomposition temperature” signifies the decomposition temperature of the blowing agent itself or the decomposition temperature of the blowing agent used in combination with a blowing auxiliary.

The “decomposition temperature” of the blowing agent signifies the heat generation initiation temperature in the DTA curve of an unvulcanized, unfoamed rubber composition determined with a thermo-gravimetric analyser TAS-100 (mfd. By Rigaku K.K.) under an air stream and at a temperature increasing rate of 10° C./min., and is defined as the temperature at the intersection point of the base line of the DTA curve (the line before the initiation of heat generation) with the maximum gradient line (straight line) in the rise of the exothermic peak.

The blowing agent having a decomposition temperature of 170° C. or above includes, for example, azodicarbonamide and dinitrosopentamethylenetetramine. The blowing agent may be used in combination with a blowing auxiliary which does not lower the decomposition temperature below 170° C. The blowing auxiliary can be, for example, zinc oxide. Combination of the above-mentioned blowing agent with such a blowing auxiliary as urea is not preferable, because it lowers the decomposition temperature below 170° C.

The amount of the blowing agent used ranges preferably from 4 to 15 parts by weight, more preferably from 5 to 10 parts by weight, relative to 100 parts by weight of rubber. When the amount of the blowing agent used is less than 4 parts by weight, lightweight foamed rubber cannot be obtained in some cases, whereas when it exceeds 15 parts by weight, foamed rubber of excessively large average cell diameter is obtained in some cases.

The foamed rubber of this invention can be produced by a process comprising the steps of:

(1) blending a mixture comprising 100 parts by weight of a rubber and 4-15 parts by weight of a blowing agent having a decomposition temperature of 170° C. or above, to obtain a composition,

(2) continuously molding the composition with a continuous molding apparatus, to obtain a molded body, and

(3) continuously heating the molded body to effect vulcanization and foaming, thereby to obtain a foamed rubber which has an average cell diameter of 1-150 μm, a hardness as determined according to JIS-K-6301 of 30-100 and a density of 0.7-1.1 kg/l.

The above-mentioned continuous molding apparatus can be, for example, an extruder and a calender roll. Examples of preferred means for continuous heating to effect vulcanization and foaming include a means selected from the group consisting of the following means (i)-(iv):

(i) a means of continuously heating in a hot air oven to effect vulcanization and foaming,

(ii) a means of continuously heating in a glass bead fluidized bed to effect vulcanization and foaming,

(iii) a means of continuously heating in a fused salt bath to effect vulcanization and foaming, and

(iv) a means of continuously heating with a heating apparatus additionally provided with a high frequency heating device upstream and/or downstream the above-mentioned means (i)-(iii).

The hot air temperature in the above-mentioned means (i) ranges preferably from 180 to 250° C., more preferably from 180 to 220° C. The temperature in the above-mentioned means (ii) ranges preferably from 170 to 230° C., and that in the above-mentioned means (iii) ranges from 170 to 230° C. When the hot air temperature is lower than the lower limit value of the respective temperature range shown above, a lightweight foamed rubber cannot be obtained in some cases; whereas when it is higher than the upper limit value, a foamed rubber having an excessively large average cell diameter is obtained in some cases. A foamed rubber having an excessively large average cell diameter does not have a smooth surface and is poor in appearance and sealing property.

The composition comprising the above-mentioned rubber and the above-mentioned blowing agent can be prepared by using known kneaders conventionally used in the field of rubber industry, e.g., a Banbury mixer, kneader, various internal mixers, kneader-extruder and open roll.

The Mooney viscosity (ML₁₊₄, 100° C.) of the composition comprising the rubber and the blowing agent determined with a Mooney viscometer ranges preferably from 30 to 160. When the Mooney viscosity is lower than 30, a foamed rubber having an excessively large average cell diameter is obtained in some cases; whereas when it exceeds 160, the moldability of the composition is poor in some cases.

The rubber and the blowing agent used for producing the foamed rubber of this invention can be used in combination with additives commonly used in the rubber industry. The additives can be, for example, reinforcing agents, such as carbon black; softeners, such as process oil; extenders, such as inorganic fillers; heat-curable processability-improving agents, such as liquid polybutadiene rubber and liquid isoprene rubber; various processing assistants and tackifiers; vulcanizing agents, such as sulfur and organic peroxides; vulcanization accelerating auxiliaries; vulcanization retarders, such as phthalic anhydride; ethylene-based resins, such as high density polyethylene (HDPE), low density polyethylene (LDPE), linear low density polyethylene (LLDPE), ethylene-vinyl acetate copolymer resin (EVA), ethylene-acrylic copolymer resin and ethylene-α-olefin copolymer resin. The use of ethylene-based resins is preferable for enhancing the effect of this invention.

The foamed rubber of this invention can be widely used as trim materials for automobiles, sealing materials for, e.g., doors and trunks of automobiles, building materials and various other industrial goods.

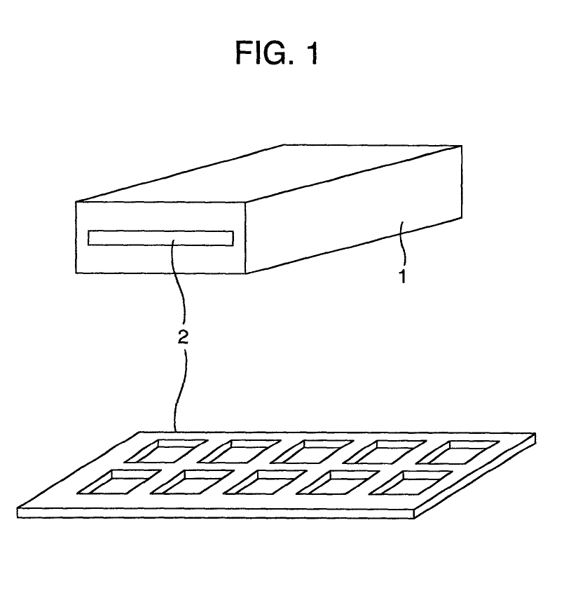

The composite of this invention is a composite which comprises, as illustrated in FIG. 1, foamed rubber and a rigid body integrally bonded to each other. In case of producing the foamed rubber used for producing the composite, such components of the foamed rubber as the rubber and the blowing agent and preferably used in combination with a metal salt of acrylic acid represented by the following formula (1) to enhance the adhesiveness between the foamed rubber and the rigid body.

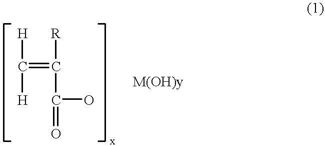

wherein R is a hydrogen atom or methyl group, M is a metal atom of mono-, di- or trivalence, x is an integer of 1-3 and y is an integer of 0-2.

The metal atom M represents a metal which can become a mono-, di- or trivalent metal cation and can be, for example, lithium, sodium, potassium, magnesium, calcium, strontium, barium, manganese, iron, cobalt, nickel, copper, silver, zinc and aluminum.

Examples of the compound represented by the above formula (1) include zinc acrylate, magnesium acrylate, aluminum acrylate hydroxide, zinc methacrylate, magnesium methacrylate, aluminum methacrylate hydroxide, and combinations of two or more thereof.

The amount of the compound represented by the above formula (1) used ranges from 0.1 to 50 parts by weight, preferably from 1 to 10 parts by weight, relative to 100 parts by weight of the rubber such as ethylene-α-olefin-non-conjugated diene copolymer rubber. When the amount is less than 0.1 part by weight, the adhesion between the foamed rubber and the rigid body is insufficient in some cases; whereas when the amount exceeds 50 parts by weight, the mechanical property of the foamed rubber obtained is deteriorated in some cases.

To enhance the adhesion between the foamed rubber and the rigid body, the rubber composition can be incorporated with such resins as resorcinol resin; resins obtained by the reaction of hexamethylene-tetramine, resorcinol and formaldehyde; and methylol-melamine resin.

The kind of the rigid body used in this invention is not particularly limited. The rigid body can be, for example, a rigid body selected from the group consisting of metals and metal alloys, such as iron, steel, cast iron, aluminum, magnesium, copper, tin, nickel, gold, silver and stainless alloys; composites of one or more of said metals and alloys with one or more other substances; engineering plastics such as polyetherketone; composites of one or more of said engineering plastics with one or more fibers, fabrics or non-woven fabrics; crystalline resins, such as polyester, polyamide, polypropylene and polyethylene; composites of one or more of said crystalline resins with one or more fibers, fabrics or non-woven fabrics; amorphous resins having a glass transition point of 80° C. or above, such as polyethylene terephthalate, polymethacrylate and polystyrene; and composites of one or more of said amorphous resins with one or more fibers, fabrics or non-woven fabrics.

The process for producing the composite of this invention is not particularly limited. It can be, for example, a process comprising the steps of:

(1) blending a mixture comprising 100 parts by weight of a rubber and 4-15 parts by weight of a blowing agent having a decomposition temperature of 170° C. or above, to obtain a composition,

(2) integrally bonding the composition and a rigid body to each other, to obtain a bonded product, and

(3) heating the bonded product to effect foaming and vulcanization of the composition, thereby to obtain a composite.

In the above-mentioned step (2), the composition and the rigid body can be integrally bonded, for example, by the following method (i), (ii) or (iii):

(i) a method which comprises inlaying the composition in the sunken parts of a rigid body having surface irregularity (having sunken and raised parts on the surface),

(ii) a method which comprises putting the composition into through-holes of a rigid body having the through-holes on the surface, and

(iii) when a rigid body made of metal is used, a method which uses a composition containing a compound represented by the above formula (1).

The use of any of the methods (i) to (iii) makes it possible to prevent the slippage between the rigid body and the foamed rubber which might develop at the time of foaming and vulcanization of the composition and to prevent the dimensional change of the composite obtained with the lapse of time. In the methods (i) and (ii), the surface irregularities or the through-holes have an anchoring effect of preventing the slippage between the rigid body and the foamed rubber and the dimensional change of the composite. In the method (iii), the adhesion between the rigid body and the foamed rubber prevents the slippage between the rigid body and the foamed rubber and the dimensional change of the composite.

The rigid body used in this invention has a Young's modules (E₀) at 23° C. of preferably 10²-10⁶ MPa, more preferably 10⁴-10⁶ MPa. When the Young's modulus is less than 10² MPa, it tends to be difficult to prevent the slippage between the rigid body and the foamed rubber and the dimensional change at the time of producing the composite and to prevent the dimensional change of the resulting composite with the lapse of time. On the other hand, when the Young's modulus exceeds 10⁶ MPa, the mold-processing of the composite obtained tends to be difficult.

The composite according to this invention has both the characteristic features of the foamed rubber described above and an excellent dimensional stability in optional directions. Particularly, composites which use a metal as the rigid body can be widely used as sealing materials used in automobile member parts such as doors and trunks, building materials and other various industrial goods.

This invention is described in detail below with reference to examples, but the invention is in no way limited thereto.

### EXAMPLE 1 AND EXAMPLE 2

A mixture of 60 parts by weight of an ethylene-propylene-5-ethylidene-2-norbornene copolymer rubber (EPDM) (Esprene 512F, a trade name, mfd. by Sumitomo Chemical Co., Ltd.), 40 parts by weight of an ethylene-propylene-5-ethylidene-2-norbornene copolymer rubber (EPDM) (Esprene 505, a trade name, mfd. by Sumitomo Chemical Co., Ltd.), 120 parts by weight of a carbon black (Seast 116, a trade name, mfd. by Tokai Carbon Co., Ltd.), 30 parts by weight of calcium carbonate, 75 parts by weight of a process oil (Sanper 2280, a trade name, mfd. by Nippon Sunoil), 5 parts by weight of zinc oxide (a vulcanization accelerating auxiliary) and 2 parts by weight of stearic acid was placed in a BR-type Banbury mixer set at 70° C. and kneaded for 5 minutes to obtain a rubber composition having a Mooney viscosity (ML₁₊₄, 100° C.) of 47.

The whole amount of the rubber composition, 1.5 parts by weight of zinc dibutyldithiocarbamate, 0.5 part by weight of tetramethylthiuram disulfide, 0.5 part by weight of tellurium diethyldithiocarbamate, 1.5 parts by weight of mercaptobenzothiazole, 7 parts by weight of an antifoaming agent (Besta BB, a trade name, mfd. by Inoue Sekkai), 1.5 parts by weight of sulfur and 10 parts by weight of azodicarbonamide (ADCA, a blowing agent) were kneaded with a 10-inch open roll temperature-controlled at 40° C., and then cut out in the form of ribon to obtain a ribon-form unvulcanized rubber composition.

The ribon-form unvulcanized rubber composition was extruded through a vent-type extruder having a diameter of 45 mm (mfd. by Nakada Zoki) to obtain a plate-form unvulcanized rubber composition having a thickness of 2 mm and a width of 20 mm.

The plate-form unvulcanized rubber composition was heated in a hot air oven set at 200° C. for 8 minutes to effect foaming and vulcanization (in the case of Example 1) or heated in a glass bead fluidized bed set at 180° C. for 5 minutes to effect foaming and vulcanization (in the case of Example 2), to obtain vulcanized foamed rubbers.

The physical properties of the foamed rubbers thus obtained were determined according to JIS-K-6250 (1993). The results obtained are shown in Table 1.

### EXAMPLE 3

The same procedure as in Example 1 was repeated except that the azodicarbonamide was replaced with dinitrosopentamethylenetetramine (DPT) and the heating time in the hot air oven (8 minutes) was changed to 5 minutes, to obtain a vulcanized foamed rubber. The physical properties of the foamed rubber were determined in the same manner as in Example 1. The results obtained are shown in Table 1.

### EXAMPLE 4

The same procedure as in Example 1 was repeated except that the EPDM was replaced with a styrene-butadiene rubber (Sumitomo SBR #1502, a trade name, mfd. by Sumitomo Chemical Co., Ltd.), the heating temperature in the hot air oven was changed from 200° C. to 240° C. and the heating time in the hot air oven (8 minutes) was changed to 7 minutes, to obtain a vulcanized foamed rubber. The physical properties of the foamed rubber were determined in the same manner as in Example 1. The results obtained are shown in Table 1.

### EXAMPLE 5

The same procedure as in Example 1 was repeated except that the amount of azodicarbonamide (10 parts by weight) was changed to 7 parts by weight, the heating temperature in the hot air oven (200° C.) was changed to 240° C., and the heating time in the hot air oven (8 minutes) was changed to 7 minutes, to obtain a vulcanized foamed rubber. The physical properties of the foamed rubber were determined in the same manner as in Example 1. The results obtained are shown in Table 1.

### EXAMPLE 6

A mixture of 50 parts by weight of an ethylene-propylene-5-ethylidene-2-norbornene copolymer rubber (EPDM) (Esprene 582F, a trade name, mfd. by Sumitomo Chemical Co., Ltd.), 50 parts by weight of an ethylene-propylene-5-ethylidene-2-norbornene copolymer rubber (EPDM) (Esprene 553, a trade name, mfd. by Sumitomo Chemical Co., Ltd.), 150 parts by weight of a carbon black (Asahi 60G, a trade name, mfd. by Asahi Carbon), 100 parts by weight of a process oil (DIANA PS430, a trade name, mfd. by Idemitsu Kosan Co., Ltd.), 5 parts by weight of complex zinc oxide (a vulcanization accelerating auxiliary) (METHA Z102, a trade name, mfd. by Inoue Sekkai), 1 part by weight of stearic acid, 1 part by weight of a polyethylene glycol having a number average molecular weight of 4000 (mfd. by Sanyo Chemical Industries, Ltd.), 1.5 parts by weight of an alkylphenol-formaldehyde resin (HITANOL, a trade name, mfd. by Hitachi Chemical Co., Ltd.) and 25 parts by weight of a low density polyethylene (LDPE) (Sumikathene G804, a trade name, mfd. by Sumitomo Chemical Co., Ltd.) was placed in a BR-type Bunbury mixer set at 70° C. and kneaded for 5 minutes, to obtain a rubber composition having a Mooney viscosity (ML₁₊₄, 100° C.) of 40.

The whole amount of the rubber composition, 1.0 part by weight of zinc dibutyldithiocarbamate, 0.3 part by weight of tetramethylthiuram disulfide, 0.2 part by weight of tellurium diethyldithiocarbamate, 1.2 parts by weight of mercaptobenzothiazole, 7 parts by weight of an antifoaming agent (BESTA 18, a trade name, mfd. by Inoue Sekkai), 1.2 parts by weight of sulfur and 5 parts by weight of azodicarbonamide (ADCA, a blowing agent) were kneaded with a 10-inch open roll temperature-controlled at 40° C. and then cut out in the form of ribon to obtain a ribon-form unvulcanized rubber composition.

The ribon-form unvulcanized rubber composition was extruded through a vent-type extruder having a diameter of 45 mm (mfd. by Nakada Zoki) to obtain a plate-form unvulcanized rubber composition having a thickness of 2 mm and a width of 20 mm.

The plate-form unvulcanized rubber composition was heated in a hot air oven set at 200° C. for 10 minutes to effect foaming and vulcanization, thereby to obtain a vulcanized foamed rubber.

The physical properties of the foamed rubber were determined in the same manner as in Example 1. The results obtained are shown in Table 1.

### COMPARATIVE EXAMPLE 1

The same procedure as in Example 1 was repeated except that the 10 parts by weight of azodicarbonamide (ADCA) was replaced with combination of 5 parts by weight of azodicarbonamide (ADCA) and 1 part by weight of urea (blowing auxiliary), to obtain a vulcanized foamed rubber. The physical properties of the foamed rubber were determined in the same manner as in Example 1. The results obtained are shown in Table 2.

### COMPARATIVE EXAMPLE 2

The same procedure as in Example 1 was repeated except that the 10 parts by weight of azodicarbonamide (ADCA) was replaced with combination of 7 parts by weight of dinitrosopentamethylenetetramine (DPT) and 0.5 part by weight of urea, to obtain a vulcanized foamed rubber. The physical properties of the foamed rubber were determined in the same manner as in Example 1. The results obtained are shown in Table 2.

### COMPARATIVE EXAMPLE 3

The same procedure as in Example 1 was repeated except that the 10 parts by weight of azodicarbonamide (ADCA) were not used, to obtain a vulcanized, unfoamed rubber. The physical properties of the unfoamed rubber were determined in the same manner as in Example 1. The results obtained are shown in Table 2.

### EXAMPLE 7

A mixture of 60 parts by weight of an ethylene-propylene-5-ethylidene-2-norbornene copolymer rubber (EPDM) (Esprene 512F, a trade name, mfd. by Sumitomo Chemical Co., Ltd.), 40 parts by weight of an ethylene-propylene-5-ethylidene-2-norbornene copolymer rubber (EPDM) (Esprene 505, a trade name, mfd. by Sumitomo Chemical Co., Ltd.), 120 parts by weight of a carbon black (SEAST G116, a trade name, mfd. by Tokai Carbon), 30 parts by weight of calcium carbonate, 75 parts by weight of a process oil (PS 430, a trade name, mfd. by Idemitsu Kosan Co., Ltd.), 5 parts by weight of zinc oxide (a vulcanization accelerating auxiliary) and 2 parts by weight of stearic acid was placed in a BR-type Banbury mixer set at 70° C. and kneaded for 5 minutes to obtain a rubber composition.

The whole amount of the rubber composition, 2.0 parts by weight of zinc dibutyldithiocarbamate, 0.5 part by weight of tetramethylthiuram disulfide, 0.5 part by weight of tellurium diethyldithiocarbamate, 1.5 parts by weight of mercaptobenzothiazole, 7 parts by weight of an antifoaming agent (BESTA PP, a trade name, mfd. by Inoue Sekkai), 1.5 parts by weight of sulfur and 10 parts by weight of azodicarbonamide (ADCA, a blowing agent) were kneaded with a 10-inch open roll temperature-controlled at 40° C., to obtain an unvulcanized, unfoamed rubber composition.

Into the unvulcanized, unfoamed rubber composition obtained above was inserted an iron sheet (rigid body) having holes as shown in FIG. 1 to obtain a bonded product comprising the rubber composition and the iron sheet integrally bonded to each other. The iron sheet used was an iron sheet (SS 41) having a thickness of 0.5 mm, width of 15 mm and length of 150 mm and a Young's modulus (E₀) of 2×10⁵ MPa.

The bonded product was press-molded so as to have a thickness of 2 mm, width of 20 mm and length of 150 mm and the resulting molded body was heated in a hot air oven set at 185° C. for 4 minutes, to effect the foaming and vulcanization of the rubber composition in the bonded product, whereby a composite was obtained. The physical properties of the foamed rubber in the composite were determined according to JIS-K-6250 (1993). Further, the dimensional change in the length direction caused by the treatment in the hot air oven, namely [the length of the composite (mm)-150]×100/150, was determined. The results thus obtained are shown in Table 3. The hardness shown in Table 3 refers to a hardness determined with a spring-type hardness tester, durometer type A (JIS-K-6253-1997).

### COMPARATIVE EXAMPLE 4

The same procedure as in Example 7 was repeated except that the iron sheet was not used, to obtain a foamed rubber. That is, the unvulcanized, unfoamed rubber composition obtained in Example 7 was cut out in the form of ribon, which was then extruded through a vent-type extruder of 45 mm diameter (mfd. by Nakada Zoki) to obtain a plate-form unvulcanized, unfoamed rubber composition having a thickness of 2 mm, width of 20 mm and length of 150 mm. The plate-form unvulcanized, unfoamed rubber composition was heated in a hot air oven set at 185° C. for 4 minutes to effect the foaming and vulcanization of the rubber composition, thereby to obtain a foamed rubber. The physical properties and the dimensional change of the foamed rubber were determined in the same manner as in Example 7. The results obtained are shown in Table 3.

TABLE 1

| | Example | | | | | |
|---|---|---|---|---|---|---|
| | 1 | 2 | 3 | 4 | 5 | 6 |
| Rubber | EPDM | EPDM | EPDM | SBR | EPDM | EPDM |
| Mooney viscosity of rubber | 47 | 47 | 47 | 31 | 47 | 40 |
| composition | | | | | | |
| Blowing agent | | | | | | |
| Kind | ADCA | ADCA | DPT | ADGA | ADCA | ADCA |
| Amount used (part by weight) | 10 | 10 | 10 | 10 | 7 | 5 |
| Decomposition temperature (° C.) | 183 | 183 | 179 | 180 | 182 | 182 |
| Heating of rubber composition | | | | | | |
| Apparatus | Hot air oven | Glass bead | Hot air oven | Hot air oven | Hot air oven | Hot air oven |
| | | fluidized bed | | | | |
| Temperature (° C.) × Time (min) | 200 × 8 | 180 × 5 | 200 × 5 | 240 × 7 | 240 × 7 | 200 × 10 |
| Surface condition | Good | Good | Good | Good | Good | Good |
| Average cell diameter (μm) | 30 | 40 | 110 | 30 | 30 | 100 |
| Density (kg/L) | 0.97 | 0.97 | 0.99 | 0.99 | 0.99 | 0.96 |
| Hardness | 60 | 63 | 70 | 62 | 60 | 68 |
| Tensile breaking strength (MPa) | 9.7 | 9.4 | 8.4 | 7.6 | 9.2 | 9.9 |
| Elongation at break (%) | 200 | 210 | 120 | 180 | 190 | 10 |

TABLE 2

| | Comparative Example | | |
|---|---|---|---|
| | 1 | 2 | 3 |
| Kind of rubber | EPDM | EPDM | EPDM |
| Mooney viscosity of rubber | 47 | 47 | 47 |
| Composition | | | |
| Blowing agent/Blowing | | | None |
| auxiliary | | | |
| Kind | ADCA/Urea | DPT/Urea | |
| Amount used (part by weight) | 5/1 | 7/0.5 | |
| Decomposition temperature | 165 | 168 | |
| (° C.) | | | |
| Heating of rubber composition | | | |
| Apparatus | Hot air oven | Hot air oven | Hot air oven |
| Temperature (° C.) × | 200 × 8 | 200 × 8 | 200 × 8 |
| Time (min) | | | |
| Surface condition | Rough | Rough | Good |
| Average cell diameter (μm) | 210 | 250 | No cells |
| Density (kg/L) | 0.87 | 0.83 | 1.21 |
| Hardness | 46 | 56 | 66 |
| Tensile breaking strength | 3.5 | 5.4 | 13.1 |
| (MPa) | | | |
| Elongation at break (%) | 140 | 130 | 330 |

TABLE 3

| | | Comparative |
|---|---|---|
| | Example 7 | Example 4 |
| Foamed rubber | | |
| Average cell diameter (μm) | 30 | 30 |
| Hardness | 57 | 57 |
| Density (kg/L) | 1.0 | 1.0 |
| Tensile breaking strength (MPa) | 9.1 | 9.1 |
| Elongation at break (%) | 350 | 350 |
| Dimensional change (%) | +0.2 | +4.7 |

What is claimed is:

1. A foamed rubber which has an average cell diameter of 1-150 μm, a hardness as determined according to JIS-K-6301 of 30-100 and a density of 0.7-1.1 kg/l.

2. The foamed rubber according to claim 1, wherein the foamed rubber comprises a foamed ethylene-α-olefin-non-conjugated diene copolymer rubber.

3. A process for producing a foamed rubber which comprises the steps of:
(1) blending 100 parts by weight of a rubber and 4-15 parts by weight of a blowing agent having a decomposition temperature of 170° C. or above, to obtain a composition,
(2) continuously molding the composition obtained in step (1) with a continuous molding apparatus, to obtain a molded body, and
(3) continuously heating the molded body obtained in step (2) to effect vulcanization and foaming, thereby to obtain a foamed rubber which has an average cell diameter of 1-150 μm, a hardness as determined according to JIS-K-6301 of 30-100 and a density of 0.7-1.1 kg/l.

4. The process for producing a foamed rubber according to claim 3, wherein the rubber used in step (1) is an ethylene-α-olefin-non-conjugated diene copolymer rubber.

5. The process for producing a foamed rubber according to claim 3, wherein the composition obtained in step (1) has a Mooney viscosity (ML₁₊₄, 100° C.) of 30-160.

6. The process for producing a foamed rubber according to claim 3, wherein the blowing agent used in step (1) is at least one member selected from the group consisting of azodicarbonamide and dinitrosopentamethylenetetramine.

7. The process for producing a foamed rubber according to claim 3, wherein the continuous heating to effect vulcanization and foaming in step (3) is conducted by a means selected from the group consisting of:
(i) a means of continuously heating in a hot air oven to effect vulcanization and foaming,
(ii) a means of continuously heating in a glass bead fluidized bed to effect vulcanization and foaming,
(iii) a means of continuously heating in a fused salt bath to effect vulcanization and foaming, and
(iv) a means of continuously heating with a heating apparatus additionally provided with a high frequency heating device upstream and/or downstream the above-mentioned means (i)-(iii).

8. A composite which comprises a foamed rubber having an average cell diameter of 1-150 μm, a hardness as determined according to JIS-K-6301 of 30-100 and a density of 0.7-1.1 kg/l and a rigid body integrally bonded to each other.

9. The composite according to claim 8, wherein the rigid body has a Young's modulus (E₀) of 10²-10⁶ MPa.

10. The composite according to claim 8, wherein the rigid body is selected from the group consisting of metals and metal alloys which are iron, steel, cast iron, aluminum, magnesium, copper, tin, nickel, gold, silver and stainless alloys; composites of one or more of said metals and metal alloys with one or more other substances; an engineering plastic which is polyetherketone; composites of said engineering plastic with one or more fibers, fabrics or non-woven fabrics; crystalline resins which are polyester, polyamide, polypropylene and polyethylene; composites of one or more of said crystalline resins with one or more fibers, fabrics or non-woven fabrics; amorphous resins having a glass transition point of 80° C. or above which are polyethylene terephthalate, polymethacrylate and polystyrene; and composites of one or more of said amorphous resins with one or more fibers, fabrics or non-woven fabrics.
